(19) United States
(12) Patent Application Publication
(10) Pub. No.: US 2001/0019791 A1
(43) Pub. Date: Sep. 6, 2001

(54) Fuel Cell Gasket Assembly and Method of Assembling Fuel Cells

(75) Inventors: Mr. Ralph L. Gooch, Plainwell, Michigan (US); Mr. Mark J. Regan, Hastings, Michigan (US); Mr. Roderick K. Ward, Hastings, Michigan (US)

Correspondence Address: Mark A. Davis, Esq., Joel E. Bair, Esq., 171 Monroe Avenue, N.W., Suite 600, Grand Rapids, Michigan, 49503, US, mad@raderfishman.com, (616) 742-3500, (616) 742-1010

(73) Assignee: Flexfab Horizons International, Inc., Hastings, 49058

(21) Appl. No.: 09/716,823

(22) Filed: Nov. 20, 2000

Related U.S. Application Data
(63) Continuation of application No. PCT/US00/04050, filed on Feb. 16, 2000.
(60) Provisional application No. 60/123,552, filed on Mar. 10, 1999.

(51) Int. Cl. H01M 8/02; H01M 8/10; H01M 2/08

(52) U.S. Cl. 429/36; 429/30; 429/44; 29/623.2

(57) ABSTRACT

### Abstract of Disclosure

The invention is an improved fuel cell sealing system comprising a proton exchange membrane sandwiched between an anode plate and a cathode plate. A gasket is provided to seal the proton exchange membrane with the anode and cathode plates. The gasket and proton exchange membrane are formed as a unitary assembly by directly molding the gasket to the proton exchange membrane, which provides structural support for the PEM and increases the ease of handling and permitting the automated assembly of multiple fuel cells.

### Cross Reference to Related Applications

This application claims under 35 U.S.C. 120 the benefit of the filing date of International Application PCT/US00/04050, filed February 16, 2000, which claims priority under 35 U.S.C. § 119 on United States provisional patent application number 60/123,552 filed March 10, 1999.

### Background of Invention

Field of the InventionThe invention relates to proton exchange membrane (PEM) fuel cells, and more particularly, to an improved PEM fuel cell gasket. In another aspect, the invention relates to an improved gasket design to aid in assembling the fuel cells.

Description of the Related ArtPEM fuel cells are well known for using hydrogen and air to generate electrical energy through a catalytic process with only water and heat as byproducts. Fuel cells have been recognized as a potential solution to extracting power from hydrocarbon-based fuels without the deleterious emissions associated with more traditional combustion systems.

A fuel cell generally comprises opposing plates between which is disposed a proton permeable membrane. One of the plates forms the anode and the other forms the cathode of an electrical circuit for the fuel cell. A gasket is disposed between each plate in the cell to seal the plates with respect to the membrane. The internal pressures of the fuel cell can be relatively high and gas is corrosive to many materials. The gasket/plate interface must resist the fuel cell internal pressure and have a relatively high resistance to corrosion. Any failure of the gasket resulting in a leaking of the hydrogen or air is highly undesirable.

Each planar surface of each plate has multiple grooves formed therein to provide flow paths for the fuel (anode plate) and air (cathode plate). A gas diffusion fabric layer (GDL) is placed between each plate and the membrane.

In operation, the fuel is reformed in such a manner so that substantially only hydrogen gas and air enters the channels of the anode plate where the hydrogen gas and air react with the coated PEM to separate the protons and the electrons. The protons pass through the membrane and the electrons are carried away through the anode to form an electric current. Air is directed into the channels of the cathode plate and reacts with the protons passing through the membrane to form water and heat as byproducts. In this manner, the fuel is converted into electrical energy through a catalytic reaction that produces only water and heat as byproducts and results in only trace amounts of noxious emissions or byproducts, unlike internal combustion devices.

A fuel cell is inherently limited in the amount of voltage that it can produce. To increase voltage, it is known to stack multiple fuel cells in a structure commonly called a fuel cell stack. A disadvantage of a fuel cell stack is that sometimes hundreds of fuel cells must be stacked on top of each other to achieve a desired electrical output and they require good sealing to prevent the escape of hydrogen gas. Gaskets are placed on each side of the PEM and the corresponding anode or cathode plate to keep the hydrogen and air from leaking.

Compression rods extend through the fuel cells to apply a compressive force to fuel cell stack. The compressive force performs multiple functions. One function is to hold together the multiple fuel cells as an integral unit. Another function is to press the anode or cathode plate against the GDL with sufficient force to maintain contact therebetween; otherwise, the hydrogen or air can escape the channels in the plates, preventing the desired distribution of hydrogen or air across the face of the GDL and reducing the performance of the fuel cell.

A fuel cell stack is susceptible to various forms of pressure that can cause leakage and which the internal gasket must prevent. For example, the fuel cell stack is subjected to the weight of the many stacked fuel cells, each of which adds to the pressure acting on each gasket. The pressure applied by the fuel cell weight is minor in comparison to the compressive force applied by the compression rods, which pressure is approximately 25 psig. The gasket must also resist the internal pressure of the hydrogen or gas, which is approximately 30 psig.

The stacking process is manually intensive and exacerbated by the relative thinness of each of the components. For example, it is common for the membrane to be approximately .0015 inches or less in thickness. There is also inherently an increased chance of misalignment of the gasket as more fuel cells are stacked. The manual handling of the membrane, the GDL, the gaskets, and the plates greatly slows the assembly time and increases the likelihood of an error during assembly. It is highly desirable to obtain a fuel cell structure that would simplify the stacking process and permit the automation of the stacking process. It is also desirable for the fuel cell stack to resist leakage.

### Summary of Invention

The invention relates to a method for making a fuel cell comprising a proton exchange membrane (PEM) positioned between an anode plate and a cathode plate, with a gasket sealing the PEM relative to the anode and cathode plates. The method comprises forming an integral gasket/membrane assembly comprising a gasket and a PEM having upper and lower surfaces connected by a peripheral edge by encapsulating with the gasket at least a portion of the edge and at least a portion of one of the upper and lower surfaces. The method further comprises positioning the gasket/membrane assembly on one of the cathode and anode plates and positioning the other of the cathode and anode plates on the gasket/membrane assembly. The method still further comprises fixing the anode and cathode plates relative to each other with the gasket/membrane assembly sealed between them.

The forming step can include molding the gasket directly to the PEM. Preferably, the forming step includes injecting a molten material into a mold cavity containing at least a portion of the PEM. Silicone rubber or suitable elastomeric material is the preferred molten material.

The injection step can include maintaining the molten material at a temperature that will not damage the PEM. Additionally, the PEM can be maintained at a temperature so that it is not damaged. The molten material can be injected on opposite sides of the PEM or injected on one side of the PEM and passed therethrough to the other side of the PEM.

An index can also be formed with the gasket. The gasket can be formed with a bead to form the index. The positioning of the gasket/membrane assembly can include aligning the bead with a channel in one of the anode and cathode plates.

The method can further comprise placing a first catalytic layer between each of the anode and cathode plates and the PEM. A GDL sheet can be placed between each of the anode and cathode plates and the PEM. Preferably, the GDL and the PEM are affixed to each other prior to the step of molding the gasket to the PEM.

The encapsulating step can further include encapsulating at least a portion of the upper and lower surfaces with the gasket. Preferably, the upper and lower surfaces are encapsulated by the gasket about the periphery of the PEM.

In another aspect, the invention relates to a gasket/membrane assembly for fuel cell of the type comprising a proton exchange membrane (PEM) having upper and lower surfaces connected by a peripheral edge. The PEM is adapted to be positioned between an anode plate and a cathode plate of a fuel cell, with a gasket sealing the PEM with respect to the anode and cathode plates. The gasket/membrane assembly comprises a gasket molded onto the PEM to encapsulate at least a portion of the edge and at least a portion of one of the upper and lower surface whereby the gasket and PEM can be handled as a unit for assembly of a fuel cell.

Preferably, the gasket is made for silicone rubber or a suitable elastomeric material. An index can be provided on the gasket/membrane assembly for aid in aligning the gasket/membrane assembly to at least one of the anode and cathode plates of a fuel cell.

At least one of the anode and cathode plates is preferably provided with a gasket groove and the gasket is dimensioned to be sealingly received within the gasket groove. The gasket groove is defined by opposing side walls connected by a bottom wall, with the side walls converging toward the bottom wall.

The gasket can have a bead that is sized to be received within a gasket groove on one of the anode and cathode plates. A catalytic layer can be disposed on at least one side of the PEM. Preferably, the gasket encapsulates at least a portion of the upper and lower surfaces.

In yet another aspect, the invention relates to a fuel cell for converting fuel into electricity by a catalytic process that at leaves predominately heat and water as the byproducts. The fuel cell comprises an anode plate and a cathode plate, each with an inner surface. The plates are arranged so that the inner surfaces are in opposing relationship. Each inner surface has a reactant groove formed thereon and a gasket groove is formed on at least one of the inner surfaces. A membrane is positioned between the opposing inner faces of the plates and overlies at least a portion of the reactant groove. A gasket is positioned within the gasket groove. A seal strip is positioned on the other inner surface opposite the gasket groove whereby when the fuel cell is assembled by a compressably holding the plates together, the gasket is deformed against the gasket groove and the seal strip to seal the plates relative to each other.

The invention also relates to a fuel cell for converting fuel into electricity by a catalytic process that leaves predominately heat and water as the by products. The fuel cell comprises an anode plate and a cathode plate, each with an inner surface. The plates are arranged so that the inner surfaces are in opposing relationship. Each inner surface has a reactant groove form thereon. A gasket groove is formed on one of the inner surfaces. The fuel cell includes a membrane positioned between the opposing inner faces of the plates and overlying at least a portion of the reactant groove. A gasket is positioned within the gasket groove to form a seal between the plates. A structural support is provided for the gasket whereby the structural support provides the gasket with a greater degree of rigidity to improve the handling of the gasket during assembly of the fuel cell.

### Brief Description of Drawings

In the drawings:

FIG. 1 is a perspective view of a fuel stack comprising multiple fuel cells according to the invention;

FIG. 2 is an exploded view of a fuel cell of FIG. 1 illustrating the fuel cell components of a membrane/gasket assembly and GDL material positioned between two opposing plates;

FIG. 3 is a sectional view taken along line 4-4 of the cell stack of FIG. 1;

FIG. 4 is a perspective view of an assembly line for automatically molding the membrane/gasket assembly and nesting for shipment;

FIG. 5 is a perspective view of an alternative construction for the membrane/gasket assembly;

FIG. 6 is an exploded view of a second embodiment of a fuel cell illustrating the fuel cell components of a membrane/gasket assembly and GDL material positioned between two opposing plates;

FIG. 7 is an enlarged sectional view illustrating the unassembled relationship between the plates, membrane, gasket, and GDL of the second embodiment;

FIG. 8 is similar to FIG. 7 except the fuel cell is assembled;

FIG. 9 is a sectional view similar to FIG. 8 without the GDL layer extending beneath the gasket;

FIG. 10 is a sectional view similar to FIG. 9 without the membrane extending beneath the gasket;

FIG. 11 is a perspective view of an alternative gasket design for the second embodiment of FIG. 6;

FIG. 12 is a sectional view taken along line 12-12 of FIG. 11;

FIG. 13 is an enlarged sectional view illustrating the unassembled relationship between the plates, membrane, gasket, and GDL of an alternative gasket construction; and

FIG. 14 is similar to FIG. 13 except the fuel cell is assembled.

### Detailed Description

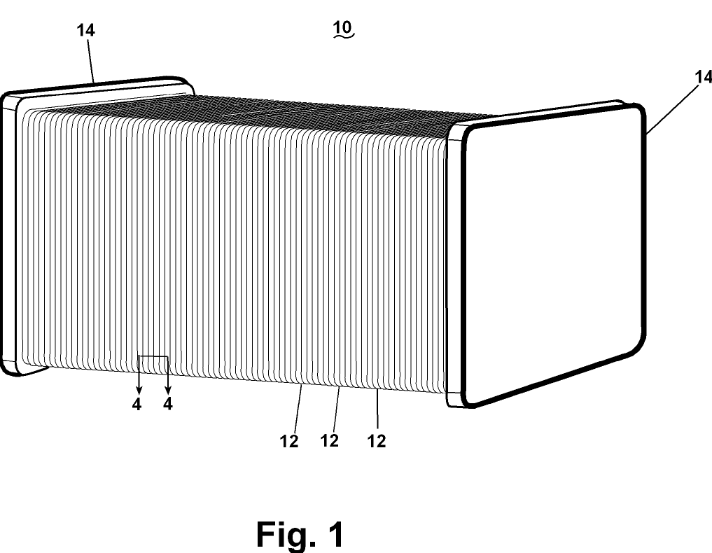

FIG. 1 illustrates a fuel stack 10 comprising multiple fuel cells 12 compressibly retained between opposing end plates 14. The fuel cell stack 10 receives hydrogen fuel and converts it to electrical power by a catalytic process. The operation of the fuel cell stack is commonly known and will not be described in further detail.

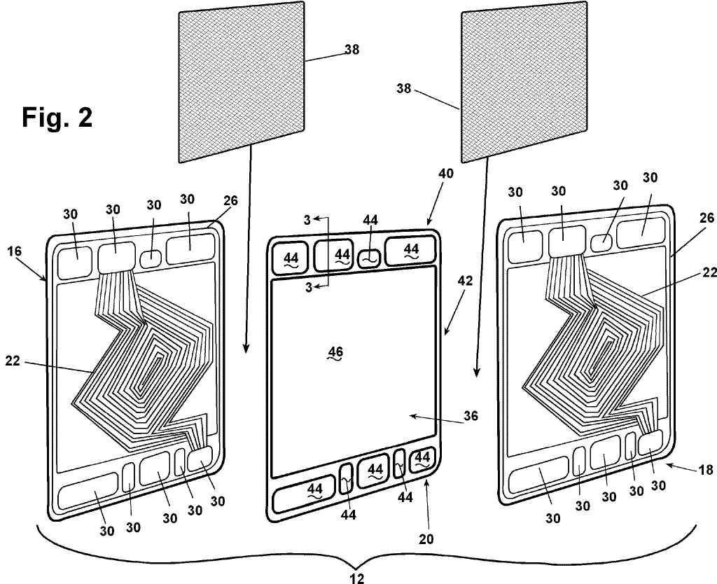

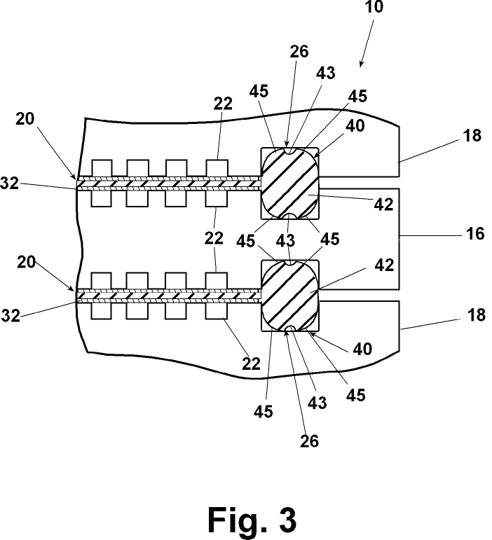

FIGS. 2 and 3 illustrate the basic components of one of the fuel cells 12 that comprise the fuel stack 10. The fuel cell 12 comprises opposing plates 16, 18 between which is disposed a pair of gas diffusion layers (GDL) 38, and between which is disposed a membrane/gasket assembly 20, according to the invention.

Each plate 16, 18 has opposing surfaces on which are formed a series of grooves 22. These grooves are well known and define a flow path for either the fuel or air across the plates during the catalytic process. Each plate also has a gasket groove 26.

At least a portion of the plates 16, 18 form the anode or cathode of an electrical circuit for the fuel cell. The plate that forms the anode is connected to the source of fuel and receives hydrogen gas within the grooves. The plate that forms the cathode is connected to a source of air that is directed through its grooves. The plates have multiple openings 30. The openings can be for many different purposes, including passageways for structural elements of the fuel cell stack, fuel, air, or electrical conduit to name a few.

The membrane/gasket assembly 20 comprises a proton exchange membrane (PEM) 36 attached to a gasket 40. The PEM 36 can be made from Nafion®, manufactured by DuPont, which is a Teflon product having an acidic base. Nafion® is limited to lower temperature assembly methods as it is currently susceptible to damage is heated to 200 °F for too long. New PEM materials having a phosphoric base can withstand temperatures up to 400 °F. The particular PEM used is not of importance to the invention other than the PEM have characteristics suitable for the particular assembly method and anticipated operating environment. The beads 42 are preferably formed with opposing channels 43 that define spaced lobes 45 that abut the closed end of the channel 26 to form separate seal lines relative thereto.

The membrane/gasket assembly 20 comprises a gasket 40 having sealing beads 42. The gasket 40 defines multiple openings 44 that correspond to openings 30 in the plates 16, 18.

The gasket 40 also defines a membrane working area 46, which substantially overlies the grooves 22 when the fuel cell is assembled to enhance the transfer of protons. The gasket material must be substantially impermeable to hydrogen. Although it need not be absolutely impermeable, the gasket need be sufficiently permeable to retain an internal pressure of 1-30 psig inside the fuel stack. A preferred gasket material is silicone rubber or suitable elastomeric material.

The GDL 38 is sized to cover the working area 46 of the PEM 36. Although the GDL 38 is shown as being separate from the PEM 36, it is within the scope of the invention for the GDL 38 to be bonded to or part of the PEM 36. It is also within the scope of the invention for the catalyst to be applied to the plate surface in addition to or in lieu of the catalyst on the GDL.

FIG. 3 is a portion of a fuel cell stack 10 illustrating the interrelationship between the plates 16, 18 and the membrane/gasket assembly 20. When assembled, the gasket 40 is received within the gasket groove 26 of the opposing plates to seal the plates with respect to the membrane/gasket assembly 20.

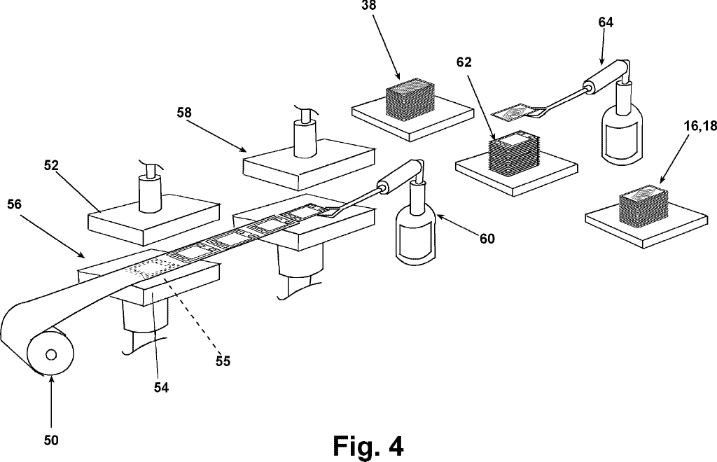

The manufacture and assembly of a fuel cell using a membrane/gasket assembly 20 will be described with reference to FIG. 4, which is a schematic illustration of the assembling apparatus. Initially, a roll 50 of PEM 36 is provided. It is preferred that the PEM 36 not include the GDL 38. However, depending on the assembly method, it is contemplated that the GDL 38 could be integrally formed with the PEM 36. It is also contemplated that the roll 50 be replaced by individual sheets.

The PEM 36 is indexed or placed corresponding to the desired size and positioned between opposing mold halves 52, 54 of a mold 56. The mold halves 52, 54 both have mold cavities 55 that when closed form the shape of the gasket 40.

The PEM 36 is positioned between the mold halves 52, 54 and positioned in registry with respect to the mold cavities 55. It is anticipated that the index of the membrane material will provide a reference point to establish registry between the roll of PEM and the mold halves 52, 54.

Once the PEM 36 is in registry with the mold halves 52, 54, the mold halves are closed and thereby compressibly retain the PEM 36 therebetween. The gasket material, preferably silicone rubber or any suitable elastomeric material, is then injected into the mold cavities on opposite sides of the membrane material and heated to the curing temperature. The injected silicone or other suitable material is kept at the heated temperature until cured. Alternatively, the gasket material can be injected into one of the cavities 55 and pass through the PEM 36 to fill the other cavity.

Although silicone rubber or flurosilicone are the preferred gasket materials, other suitable elastomeric materials can be used. It is preferred that the gasket materials cure at a temperature less than a temperature that is deleterious to the PEM 36.

Preferably, the portion of the mold adjacent the membrane working area 46 is cooled to insure that the membrane does not degrade during the molding of the gasket. It is preferred that the portion of the mold adjacent the membrane working area is kept below 200°F. Temperatures above 200°F tend to degrade the beneficial characteristics of a Nafion® PEM. To accomplish this, the mold can be cooled by circulating a coolant, such as water, through the relevant portions of the mold halves.

Once the gasket material has cured, the mold halves are opened and the PEM membrane material is advanced to the next index position, placed in registry with respect to the mold halves and the gasket molding process is repeated.

The output from the mold 56 comprising membrane/gasket assemblies connected by the web of PEM 36 is advanced to a trimming station 58, which is preferably a punch press or similar machine. The trimming station cuts the membrane/gasket assembly 20 from the roll 50 of PEM 36 and simultaneously punches out those portions of the membrane located in the openings 44 if the PEM is not pre-punched. After the trimming process, the membrane/gasket assembly 20 is ready for packaging.

A robotic 60 or a similar device moves the membrane/gasket assembly 20 from the trimming station 58 and mounts it onto a partially assembled fuel cell stack 60. The membrane/gasket assembly 20 is aligned with the plate 18 of the partially assembled fuel cell stack 62 so that the seal is aligned with the corresponding grooves 28 in the surface of the plate 18. A second robotic arm 64 then sequentially positions a GDL sheet 38 and then a plate 16 on top of the just positioned GDL 38 and membrane/gasket assembly 20 so that the gasket seal is received within the seal groove 26 on the surface of the plate 16. This process is repeated until the desired number of fuel cells 12 are formed in the fuel cell stack 62.

In the event the GDL 38 is integral with the PEM 36, then it will not be necessary to place the GDL 38 on the stack 62. Also, although not preferred, the PEM and GDL can be manually loaded into and/or removed from the mold instead of being fed from a roll. The manual process will result in an equally suitable membrane/gasket assembly 20, but will undesirably increase the manually handling during the process. The automation of the fuel cell stack assembly can be made possible by the integral membrane/gasket assembly 20, which, when combined, provides much greater structural integrity than either one alone, especially the membrane. The greater structural integrity greatly increases the ease of handling and positioning of the membrane/gasket assembly 20 over the prior art method of handling each separately. The gasket 40 in combination with the grooves in the plates 10, 18 aid in positioning the membrane/gasket assembly 20. The increased structural integrity and the ease of positioning associated wit the membrane/gasket assembly 20 permits the automation of the assembly of the fuel cell 12.

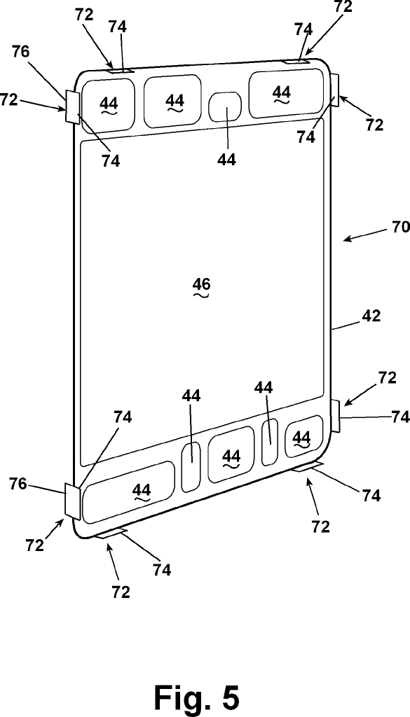

FIG. 5 illustrates an alternative membrane/gasket assembly 70 construction. The membrane/gasket assembly 70 is very similar to the membrane/gasket assembly 20, except that positioning tabs 72 are formed adjacent the corners or as required of the membrane/gasket assembly 70. The positioning tabs 76 preferably include opposing positioning elements 72, 74 that extend outwardly a sufficient distance so that they will not be trapped between the opposing plates 16, 18 during assembly. The positioning tabs 72, 74 are used to position the membrane/gasket assembly 70 with respect to the plates 16, 18 during assembly.

With the membrane/gasket assembly 70, there is less of a need for the plates to have a gasket groove for its positioning function. However, the gasket groove still provides a valuable sealing function.

If the gasket groove is not used, the gasket 70 merely abuts the surface of the plates 16, 18 to form the seal. Typically, the height of the peripheral bead will need to be reduced to the height of the remainder of the gasket.

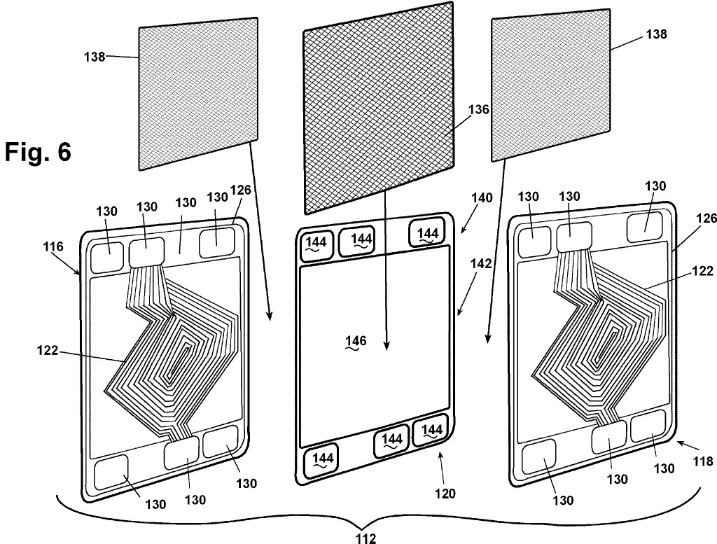

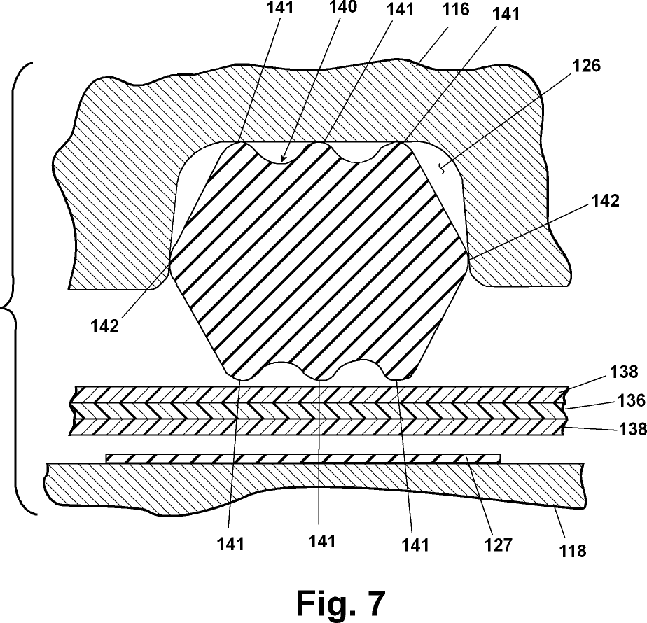

FIGS. 6 and 7 illustrate a second embodiment of a fuel cell 112 according to the invention. The fuel cell 112 comprises a pair of electrically conductive plates 116 and 118 between which is disposed a membrane/gasket assembly 120. A series of grooves 122 are provided on each face of the plates 116, 118, respectively, and direct the flow of fuel or oxygen as part of the catalytic process. A seal groove 126 is provided on one face of the plate 116. The seal groove preferably has an inwardly tapered cross section defined by inwardly slanting side surfaces connected by a generally planar bottom surface.

A compression strip 127 (see FIG. 7) is provided on the opposing face of plate 118 and corresponds to the shape of the seal groove 126 of the plate 116. The compression strip 127 aligns with the seal groove 126 when the fuel cell is assembled.

Multiple openings 130 extend through the plates and, when multiple fuel cells are stacked, define passages for fuel, oxygen, compression rods, waste products, etc. The compression strip 127 preferably circumscribes the openings 130.

The membrane/gasket assembly 120 comprises a proton exchange membrane 136 sandwiched between two GDL layers 138. As with the other embodiments, the proton exchange membrane 136 and the GDL layers 138 may be separate pieces or formed together as a composite or laminate and are collectively referred to as the membrane.

The membrane/gasket assembly 120 further includes a gasket 140 that is shaped to be received within the seal groove 126. The gasket 140 preferably has multiple lobes 141 arranged in sets on opposite surfaces of the gasket 140. Protuberances 142 are formed on the gasket sidewalls, which connect the upper surfaces of the gasket 140. The gasket defines portals 144 that correspond to and circumscribe the openings 130 on the plates. The gasket 140 also defines a membrane working area 146 that overlies a substantial portion of the grooves 122.

As is best seen in FIG. 7, in the undeformed state, the gasket 140 is sized so that the protuberances 142 of the sidewalls are adjacent to or just abut the sidewalls of the plate 116. The protuberances 142 are sized and pressed within the groove 122 to retain the gasket therein through compressive forces, frictional forces, or both. The lobes 141 contact the bottom of the groove 126. In the uncompressed state, the gasket 140 leaves substantial portions of the groove 126 unfilled.

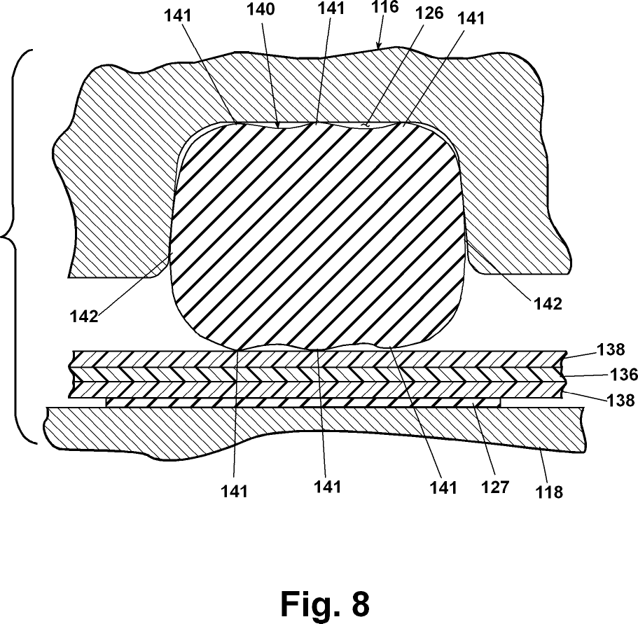

As best seen in FIG. 8, when the fuel cell 112 is assembled, the gasket 140 deforms to substantially fill the seal groove 126. However, the lobes 141 still provide discreet seals at their respective interfaces with the bottom surface of the groove 126 to thereby define multiple seal lines between the gasket and the bottom surface of the groove 126. In the compressed state, the protruding sidewalls 142 are compressed and abut the groove side surfaces for substantially the entire depth of the groove 126.

In addition to the gasket 140 forming a seal with respect to the plate 116, the gasket 140 also seals the membrane with respect to the plate 118. In the compressed state, the lobes 141 contacting the membrane are deformed to expand the contact area between the lobes and the membrane, forming discreet seals at each of the contact points. Additionally, the membrane is pressed into the compression strip 127 to enhance the seal between the gasket 140 and the plate 118.

For the second embodiment, it should be noted that the compression strip 127 is preferred, but is optional. The gasket 140 can typically apply a sufficient force to the membrane to seal it with respect to the plate 118. However, the elastomer layer 127 enhances the seal between the gasket 140 and the plate 118.

It should also be noted that as illustrated in FIGS. 6-8, the membrane is separate from the gasket 140. However, it is within the scope of the invention for the gasket 140 to be integrally connected or formed with the membrane. If the gasket 140 is thus associated with the membrane, it is preferred that the lobes 141 are not provided on any surface of the gasket 140 contacting the membrane.

It should further be noted that FIGS. 7 and 8 exaggerate the gap between the plates 116 and 118 and the GDL 138 and PEM 136 layers (also know as the soft goods) for clarity sake. In the actual assembly, the soft goods will contact the plates 116 and 118. The compression force applied to the fuel cell stack is partially resisted by the continuous contact between the plates and the soft goods. It is within the scope of the invention for the GDL not to extend under the gasket. For that matter, none of the soft goods have to extend under the gasket as illustrated. The soft goods can terminate prior to reaching the gasket, improving the overall contact between the soft goods and the plates.

A benefit of the second embodiment is that the gasket 140 is uniquely shaped so that it can easily be received within the seal groove 126 while still providing multiple seal lines with respect to the gasket and the channel 126 in the compressed state. The multiple seal lines are formed by the side protuberances 142 and the lobes 141 with the groove and interfaces of plates. The seal between the gasket 140 and the seal groove 126 is enhanced by the seal groove 126 having a tapered cross section. Although illustrated with three lobes 141, it is within the scope of the invention for there to be as few as two lobes.

The shape of the gasket 140 in relation to the shape of the groove 126 is very important in obtaining the required performance from the gasket 126. The collective gaskets 126 in a fuel cell stack must be resist the stack compression forces a sufficient amount to prevent the anode and cathode plates from contacting each other, which would electrically short the fuel cell stack. The contact between the GDL or soft goods and the plates combines with the compressive resistance of the gaskets to keep the plates from contacting.

Lateral leaking is controlled by the interaction between the gasket and the groove. The lobes 141 of the gasket and the protuberances 142 deform when compressed in such a manner to substantially fill the groove 126. Each of the lobes 141 and protuberances 142 effectively form a seal line that resists the lateral movement of the hydrogen or air from the working area 146. The angle of the surfaces of the lobes and protrusions are selected to control the compressed shape of the gasket to ensure its contact with the plate and filling of the groove. The tapered sidewalls of the groove 126 aid in the gasket being snuggly received within the groove. The taper is preferably controlled along with the cross-sectional shape of the gasket so that the gasket tends to fill in the groove when compressed.

The gasket 142 and groove 126 must be shaped to resist the compressive force of approximately 25 psig. The gasket 142 and groove must be able to resist internal pressures up to approximately 30 psig.

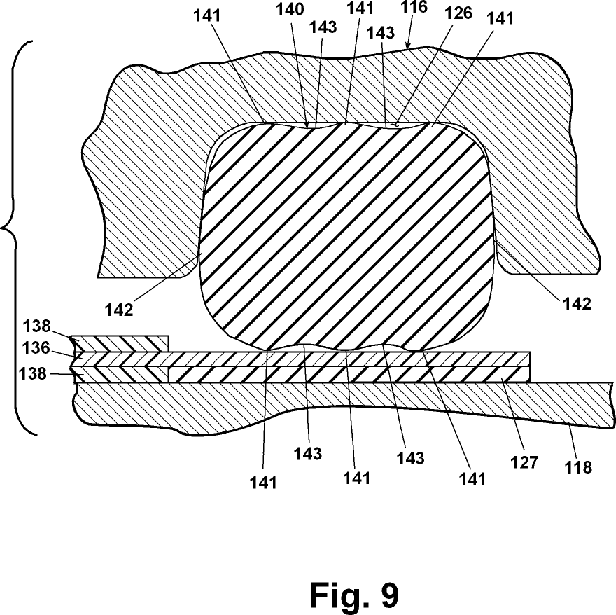

FIG. 9 illustrates a first alternative construction of the second embodiment fuel cell illustrated in FIGS. 6-8. The first alternative construction is identical to the second embodiment except that the GDL layers 138 doe not extend beneath the gasket 140. Since the GDL layers 138 function to disperse the gas over the working area 146, the edges of the GDL will not need to be sealed if they are sealed by or do not extend beyond the gasket 140. Therefore, the first alternative construction reduces the assembly complexity of the fuel cell.

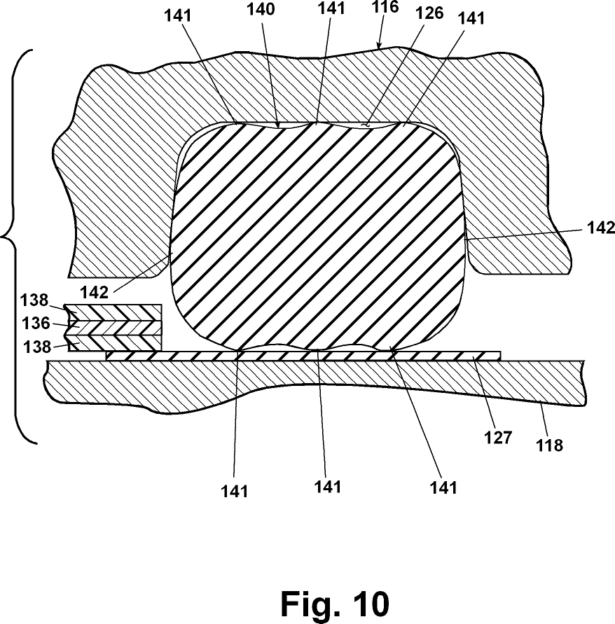

FIG. 10 illustrates a second alternative construction of the second embodiment fuel cell, which is similar to the second embodiment except that neither the GDL layers 138 or the PEM 136 extend beneath the gasket 140. The second alternative construction reduces the likelihood that the PEM can interfere with the seal between the gasket 140 and the seal strip 127, while increasing the difficulty of positioning and holding the PEM 136 in the desired location during assembly. That is, the gasket 140, when overlying the PEM serves to hold the PEM in place during the assembly of the multiple fuel cells. Without the gasket holding the PEM in place, the PEM is more susceptible to movement during assembly. However, once assembled, the compression forces acting on the PEM from the plates 116 and 118 are sufficient to hold the PEM in the assembled position.

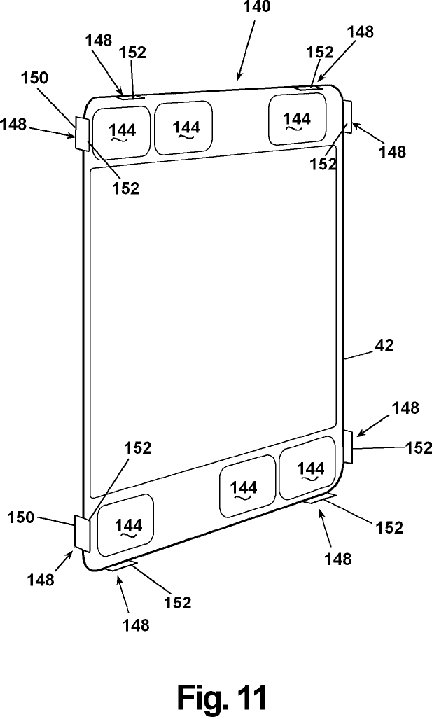

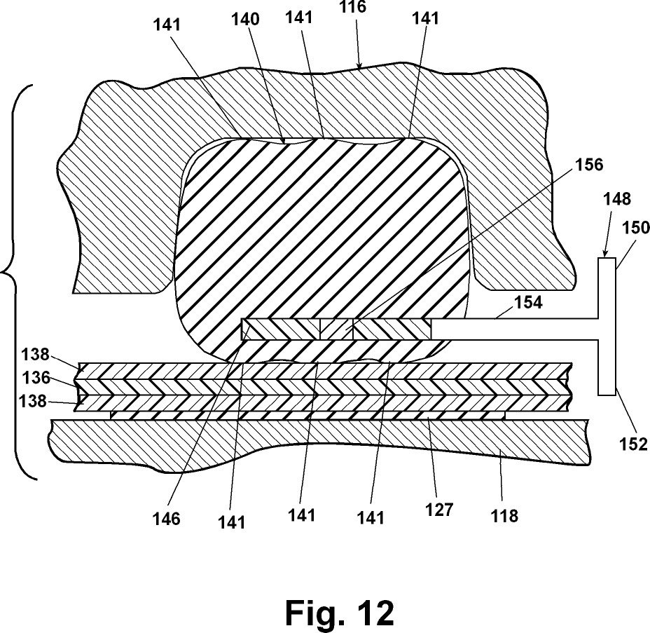

FIGS. 11 and 12 illustrate an alternative construction of the second embodiment fuel cell. The alternative construction is substantially identical to the membrane/gasket assembly 120 as shown in FIGS. 6-8, except that a backbone 146 is formed within the gasket 140 to provide the gasket with structural rigidity. The backbone preferably includes multiple positioning tabs 148 comprising opposing elements 150, 152, supported by a spacer 154 integrally formed with the backbone 146. The positioning tabs 148 are preferably located at the corners of the gasket 140 to help aid in the alignment of the gasket 140 with respect to the plates 116 and 118. The backbone 146 additionally includes multiple openings 156 through which the gasket material can flow during the forming of the gasket to mechanically lock the gasket 140 to the backbone 146. The backbone 146 can be placed anywhere within the interior of the gasket 140. The backbone 146 is preferably placed in a position to permit the positioning tabs 172 to extend outwardly between the plates 116 and 118.

In addition to being made from a separate element, the backbone 146 can be made from a dual durometer material. For example, the gasket can be made from a hard rubber center and a softer exterior. The hard rubber center forms the backbone.

The backbone improves the handling characteristics of the gasket, which is otherwise pliable and substantially bends under its own weight. The rigidity imparted by the backbone to the gasket is sufficient for the gasket to be automatically assembled.

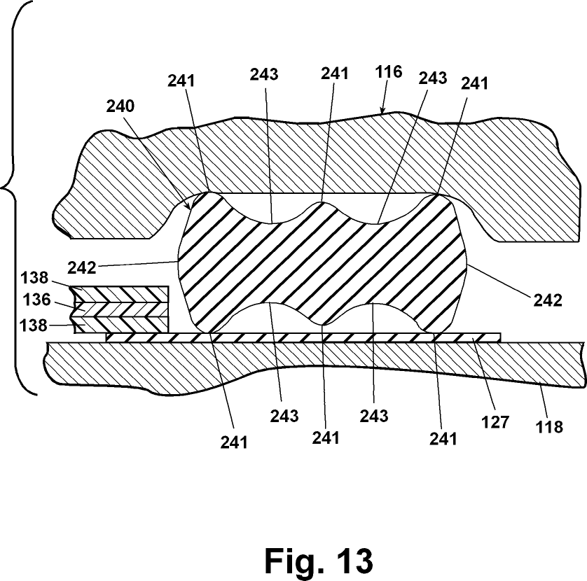

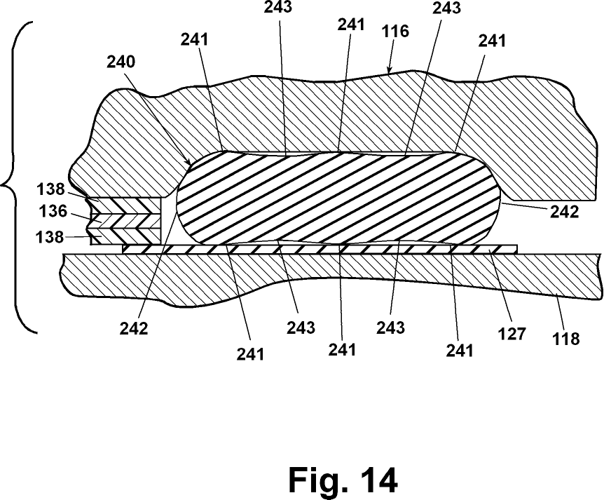

FIGS. 13 and 14 illustrate an alternative gasket 240 whose cross section is illustrated in the context of the second embodiment fuel cell but which can be used with either the first or second embodiment. The alternative gasket includes three lobes 241, preferably on opposing sides of the gasket 241 as does the gasket 140. The lobes 241 form seal lines relative to the groove 126 of the plate 116 and the seal strip 127 or with the other plate 118 if the seal strip is not used.

The lobes can be regularly or irregularly spaced relative to each other. It is preferred that when the gasket 240 is uncompressed, the middle lobe 241 is shorter than the other two outer lobes 241. In this manner, the plates 116, 118 of the fuel cell can be compressed to a greater degree or placed under a greater compressive force, in other words, without the gasket 240 becoming solid when its ability to compress is exceeded. In other words, the alternative gasket 240 has a reduced cross-sectional area for the volume it fills in the groove 126 in the uncompressed state. The reduced cross-sectional area permits the plates 116, 118 to be compressed with a greater force and positioned closer to each other than in the second embodiment without the gasket becoming solid, which permits the gasket 240 to maintain its discreate seals relative to one of both of the plates 116, 118 or seal strip 127.Channels 243 separate the lobes 241 so that the lobes have a generally concave shape and the channel 243 has a generally convex shape and connects adjacent loves. The channels 243 and loves 241 preferably have an arcuate cross section.

As with the gasket 140, the gasket 240 has protuberances 242 extending outwardly from the sides of the gasket 100 when the gasket 100 is uncompressed. The protuberances can be sized such that they retain the gasket within the groove during assembly by compressive and/or compressive forces. The protuberances 242 also laterally expand to seal against side walls of the groove 126.

Preferably, each lobe 241 has a radius of curvature between approximately 0.005 in. to 0.010 in., such as approximately 0.08 in., for example. The channels 243 preferably have a radius of curvature between approximately 0.20 in. to 0.25 in., such as approximately 0.23 in., for example. The protuberances 242 preferably have a radius of curvature between approximately 0.02 in. to 0.04 in., such as approximately 0.03 in., for example. The uncompressed thickness of the gasket 240 is preferably between approximately 0.03 in. to 0.10 in., such as approximately 0.06 in., for example. While the invention has been specifically described in connection with certain specific embodiments thereof, it is to be understood that this is by way of illustration and not of limitation, and the scope of the appended claims should be construed as broadly as the prior art will permit.

Claims

A method for making a fuel cell comprising a proton exchange membrane (PEM) positioned between an anode plate and a cathode plate with a gasket sealing the PEM with respect to the anode and cathode plates, the method comprising:
forming an integral gasket/membrane assembly comprising a gasket and a PEM having upper and lower surfaces connected by a peripheral edge by encapsulating with the gasket at least a portion of the edge and at least a portion of one of the upper and lower surfaces,
positioning the gasket/membrane assembly on one of the cathode and anode plates,
positioning the other of the cathode and anode plates on the gasket/membrane assembly; and
fixing the cathode and the anode plates relative to each other with the gasket/membrane assembly sealed between them.

The method according to claim 1, wherein the forming step includes molding the gasket to the PEM.

The method according to claim 2, wherein the forming step includes injecting a molten material into a mold cavity containing at least a portion of PEM.

The method according to claim 3, wherein the molten material is silicone rubber.

The method according to claim 3, wherein the injection step includes maintaining the molten material at a temperature that will not damage the PEM.

The method according to claim 3, wherein the injection step includes maintaining the PEM at a temperature so it is not damaged.

The method according to claim 3, wherein the injection step includes injecting the molten material on opposite sides of the PEM.

The method according to claim 3, wherein the injection step includes injecting the molten material on one side of the PEM and letting the molten material pass through to the other side of the PEM.

The method according to claim 3, wherein the forming step includes forming an index with the gasket.

The method according to claim 9, and further comprising molding the gasket with a bead to form the index.

The method according to claim 10, wherein the positioning of the gasket/membrane assembly includes aligning the bead with a channel in one of the anode and cathode plates.

The method according to claim 2, and further comprising placing a first catalytic layer between each of the anode and cathode plates and the PEM.

The method according to claim 12, and further comprising placing a GDL sheet between each of the anode and cathode plates and PEM.

The method according to claim 13, and further comprising affixing the GDL to the PEM prior to the step of molding the gasket to the PEM.

The method according to claims 1, wherein the encapsulating step further comprises encapsulating at least a portion of the upper and lower surfaces with the gasket.

The method according to claim 15, wherein the encapsulating step further comprises encapsulating the edge and the upper and lower surfaces about the periphery of the PEM.

A gasket/membrane assembly for a fuel cell of the type comprising a proton exchange membrane (PEM) having upper and lower surfaces connected by a peripheral edge positioned between an anode plate and a cathode plate, and a gasket sealing the PEM with respect to the anode and cathode plates, the gasket/membrane assembly comprising a gasket molded onto the PEM to encapsulate at least a portion of the edge and at least a portion of one of the upper and lower surfaces whereby the gasket and PEM can be handled as a unit for assembly of a fuel cell.

The gasket/membrane assembly according to claim 17, wherein the gasket is made from silicone rubber.

The gasket/membrane assembly according to claim 17 and further comprising an index provided on the gasket/membrane assembly for aligning the gasket/membrane assembly to at least one of the anode and cathode plates of a fuel cell.

The gasket/membrane assembly according to claim 17, wherein at least one of the anode and cathode plates has a gasket groove and the gasket is dimensioned to be sealingly received within the gasket groove.

The gasket/membrane assembly according to claim 20 wherein the gasket groove is defined by opposing sidewalls connected by a bottom wall and the sidewalls converge toward the bottom wall.

The gasket/membrane assembly according to claim 21, wherein the gasket has a bead sized to be received within the gasket groove.

The gasket/membrane assembly according to claim 17 and further comprising a catalytic layer disposed on at least one side of the PEM.

The gasket/membrane according to claim 17, wherein the gasket encapsulates at least a portion of the upper and lower surfaces.

The gasket/membrane according to claim 24, wherein the gasket encapsulates the edge and the upper and lower surfaces about the periphery of the PEM.

A fuel cell for converting fuel into electricity by a catalytic process that leaves predominantly heat and water as the byproducts, the fuel cell comprising:
an anode plate and a cathode plate, each with an inner surface, wherein the plates are arranged so that the inner surfaces are in opposing relationship, each inner surface having a reactant groove formed thereon;
a membrane positioned between the opposing inner surfaces of the plates and overlying at least a portion of the reactant grooves;
a gasket positioned between the inner surfaces of the plates; and
a seal strip positioned on the inner surface opposite the gasket whereby when the fuel cell is assembled by compressibly holding the plates together, the gasket is deformed against the seal strip to seal the plates relative to each other.

The fuel cell according to claim 26 wherein a gasket groove is formed on one of the inner surfaces and at least a portion of the gasket is received within the gasket groove whereby when the fuel cell is assembled, the gasket is deformed against the gasket groove and the seal strip.

The fuel cell according to claim 27 wherein the gasket groove is defined by opposing sidewalls connected by a bottom wall and the gasket is sized such that it abuts the groove sidewalls as the gasket is placed in the gasket groove to retain the gasket therein prior to the assembly of the plates.

The fuel cell according to claim 28 wherein the gasket groove sidewalls converge toward the bottom wall.

The fuel cell according to claim 26 wherein the seal strip is a layer of
elastomer.

The fuel cell according to claim 30 wherein the elastomer is silicone.

The fuel cell according to claim 26 wherein the seal strip is about .005 inches thick.

The fuel cell according to claim 26 wherein the gasket further comprises a structural support.

The fuel cell according to claim 33 wherein a portion of the structural support is encapsulated within the gasket.

The fuel cell according to claim 34 wherein the structural support comprises multiple openings through which a portion of the gasket passes to mechanically lock together the gasket and the structural support.

The fuel cell according to claim 33 wherein the structural support includes positioning tabs for aligning the plates relative to each other.

The fuel cell according to claim 36 wherein the positioning tabs extend beyond the periphery of the gasket.

The fuel cell according to claim 26, wherein the membrane comprises a proton exchange membrane (PEM).

The fuel cell according to claim 38, wherein a portion of the PEM extends beneath the gasket whereby the gasket holds the PEM in position during assembly.

The fuel cell according to claim 39, wherein the membrane further comprises a GDL layer disposed between the PEM and at least one of the inner surfaces.

The fuel cell according to claim 40, wherein the membrane further comprises a GDL layer disposed between the PEM and at least one of the inner surfaces.

The fuel cell according to claim 41, wherein the membrane comprises an upper and lower surface connected by an edge surface and the gasket encapsulates at least a portion of one of the upper and lower surfaces and the edge surface.

The fuel cell according to claim 42, wherein the gasket encapsulates at least a portion of the upper and lower surfaces with the gasket.

The fuel cell according to claim 43, wherein the gasket encapsulates the edge and the upper and lower surfaces about the periphery of the PEM.

The fuel cell according to claim 26, wherein the membrane has a portion extending between the gasket and one of the plates so that the gasket presses the membrane against the other plate to hold the membrane in position during assembly.

A fuel cell for converting fuel into electricity by a catalytic process that leaves predominantly heat and water as the byproducts, the fuel cell comprising:
an anode plate and a cathode plate, each with an inner surface, the plates are arranged so that the inner surfaces are in opposing relationship, each inner surface having a reactant groove formed thereon;
a membrane positioned between the opposing inner surfaces of the plates and overlying at least a portion of the reactant grooves;
a gasket positioned between the plates and forming a seal therebetween; and
a structural support is provided for the gasket whereby the structural support provides the gasket with increased rigidity to improve the handling of the gasket during assembly of the fuel cell.

The fuel cell according to claim 46 wherein a portion of the structural support is encapsulated within the gasket.

The fuel cell according to claim 47 wherein the structural support comprises multiple openings through which a portion of the gasket passes to mechanically lock together the gasket and the structural support.

The fuel cell according to claim 48 wherein the structural support includes positioning tabs for aligning the plates relative to each other.

The fuel cell according to claim 49 wherein the positioning tabs extend beyond the periphery of the gasket.

The fuel cell according to claim 46, wherein the membrane comprises an upper and lower surface connected by an edge surface and the gasket encapsulates at least a portion of one of the upper and lower surfaces and the edge surface.

The fuel cell according to claim 51, wherein the gasket encapsulates at least a portion of the upper and lower surfaces with the gasket.

The fuel cell according to claim 52, wherein the gasket encapsulates the edge and the upper and lower surfaces about the periphery of the membrane.

The fuel cell according to claim 46, wherein the membrane has a portion extending between the gasket and one of the plates so that the gasket presses the membrane against the other plate to hold the membrane in position during assembly.

The fuel cell according to claim 54, and further comprising a seal strip positioned on the other plate and the gasket presses the membrane against the seal strip.

The fuel cell according to claim 55, wherein the one plate has a gasket groove formed therein in alignment with the seal strip and at least a portion of the gasket is received within the gasket groove.

A fuel cell for converting fuel into electricity by a catalytic process that leaves predominantly heat and water as the byproducts, the fuel cell comprising:
an anode plate and a cathode plate, each with an inner surface, wherein the plates are arranged so that the inner surfaces are in opposing relationship, each inner surface having a reactant groove formed thereon;
a gasket positioned between the plates and forming a seal therebetween; and
a membrane positioned between the opposing inner faces of the plates in overlying relationship to at least a portion of the reactant grooves and having a portion that extends between the gasket and one of the plates whereby the gasket holds the membrane in position during assembly of the fuel cell as the plates are compressed together.

The fuel cell according to claim 57, wherein the membrane comprises an upper and lower surface connected by an edge surface and the gasket encapsulates at least a portion of one of the upper and lower surfaces and the edge surface.

The fuel cell according to claim 58, wherein the gasket encapsulates at least a portion of the upper and lower surfaces with the gasket.

The fuel cell according to claim 59, and further comprising a seal strip positioned on the other plate and the gasket presses the membrane against the seal strip.

The fuel cell according to claim 60, wherein the one plate has a gasket groove formed therein in alignment with the seal strip and at least a portion of the gasket is received within the gasket groove.
